(19) United States
(12) Patent Application Publication
(10) Pub. No.: US 2018/0170621 A1
(43) Pub. Date: Jun. 21, 2018

(54) Machine for Assembling a Container Accommodating Perishable Goods

(71) Applicant: Eco Pack Green Box USA LLC, Karmey Yosef (IL)

(72) Inventor: Yosef Heyman, Karmey Yosef (IL)

(73) Assignee: Eco Pack Green Box USA LLC, Karmey Yosef (IL)

(21) Appl. No.: 15/577,410

(22) PCT Filed: May 25, 2016
(86) PCT No.: PCT/IL2016/050545

§ 371 Date: Nov. 28, 2017

Related U.S. Application Data
(60) Provisional application No. 62/167,284, filed on May 28, 2015.

(51) Int. Cl. B65D 25/16; B31B 70/00; B31B 70/64

(52) U.S. Cl. CPC B65D 25/16; B31B 2120/406; B31B 70/64; B31B 70/006

(57) ABSTRACT

A machine for assembling a container accommodating perishable good comprises bag placing means configured for inserting a bag into a frame and everting a bag rim portion over the frame and bag securing means. The bag securing means further comprises: an internal member having a perimeter conformable with a cross section of the bag thereat the internal member insertable into a main portion of the bag; and at least one external member conformably pressing the rim portion everted over the frame to the main portion. The internal and external members are provided with cooperatively disposed effectors configured to secure the rim portion and the main portion together when the rim and main portions are pressed to each other.

### FIELD OF THE INVENTION

The invention relates to an apparatus for producing containers and, more particularly, to an apparatus for assembling containers accommodating perishable goods.

### BACKGROUND OF THE INVENTION

There is known in the art PGP 2014/0291193 to Yosef Heyman disclosing an open collapsible top container for loading, storing and shipping goods in bulk. The container comprises a rigid structure including a rectangular carrying sub-frame of at least four frame members defining a perimeter of the frame; and four legs extending from the four corners of the frame. A bag has a main portion for accommodating the goods in bulk and a rim of the bag. The bag rim is mechanically secured to the perimeter of the rectangular carrying sub-frame such that the portion for accommodating the goods is downwardly housed into the rectangular carrying sub-frame.

Since the aforesaid container is used in transportation of perishable goods in a massive way, automation of securing the bag to the frame will provide a sufficient reduction in transportation expenses.

GB 1530733 discloses an apparatus for producing containers. Each consists of a rigid outer casing and a lining bag. The apparatus comprises means for forming a tube of a strip of packaging material, means for forming lining bags by successively closing the end of the tube to form a bag bottom, advancing the tube by an amount appropriate to the length of a lining bag, transversely severing the tube to a separate a bag length therefrom and transversely reclosing the open end of the tube to form a new bag bottom, means for positioning non-lined rigid casing successively in line with the tube and means for inserting a respective closed end of the tube into each rigid casing to provide a lining bag therein, the tube forming means comprising a hollow forming mandrel and the tube end inserting means comprising a plunger arranged for reciprocation within the hollow mandrel between retracted and extended limit positions, the lining bag forming means being arranged to be operated in synchronism with the rigid casing positioning means and the apparatus being so arranged that, the plunger urges the closed end of the tube into an already positioned rigid casing and guides the tube during its movement into a final position within the rigid casing.

In the market, there is a known family of poly bag inserters ZIM-11, FLEXIM-31 and RAZIM-21-G. They are also characterized by inserting the poly bag into a rigid casing.

Thus, there is a long-felt and unmet need for automation of production of perishable-goods containers. Their massive use in transportation of fruits and vegetables determines importance of reduction of transportation expenses. Reduction of the hand work portion results in cost cutting.

### SUMMARY OF THE INVENTION

It is hence one object of the invention to disclose a machine for assembling a container accommodating perishable goods. Each container comprises a bag has a main portion and a rim portion adjacent to an open end thereof. The bag is securable to a frame.

The aforesaid machine comprises: (a) bag placing means configured for inserting the bags into the frames and everting the rim portion of the bag over the frame; and (b) bag securing means.

It is a core purpose of the invention to provide the bag securing means further comprising: (a) an internal member having a perimeter conformable with a cross section of the bag; the internal member insertable into the main portion of the bag; and (b) at least one external member conformably pressing the rim portion everted over the frame to the main portion. The internal and external members are provided with cooperatively disposed effectors configured to secure the rim portion and main portion together when the rim and main portions are pressed to each other.

Another object of the invention is to disclose the machine comprising a conveyor having a moving belt configured for carrying the frames through the bag placing means and bag securing means.

A further object of the invention is to disclose the machine comprising feeding means configured for feeding the frame to the conveyor.

A further object of the invention is to disclose the machine comprising collecting means configured for collecting assembled container from the conveyor.

A further object of the invention is to disclose the conveyor comprising infeed and outfeed portions.

A further object of the invention is to disclose the infeed and outfeed portions which are parallel to each other and cyclically interconnected by pushing means.

A further object of the invention is to disclose the conveyor which is provided with a plurality of mountings configured for carrying the frames.

A further object of the invention is to disclose the bag having a gusset pattern.

A further object of the invention is to disclose the bag which is made of a material selected from the group consisting of: polyethylene, polypropylene, paper, jute, and any combination thereof.

A further object of the invention is to disclose the effectors further comprising a mechanism selected from the group consisting of an ohmic heating element, an ultrasound piezo heating, needle arrangement for stitching and any combination thereof.

A further object of the invention is to disclose a method of assembling containers accommodating perishable goods. Each container comprises a bag having a main portion and a rim portion adjacent to an open end thereof. The bag is securable to a frame. The method comprising the steps of: (a) providing a machine for assembling containers accommodating perishable goods; the machine comprising: (i) bag placing means configured for inserting the bag into the frame and everting the rim portion of the bag over the frame; and (ii) bag securing means; the bag securing means further comprises: (1) an internal member having a perimeter conformable with a cross section of the bag; the internal member insertable into the main portion of the bag; and (2) at least one external member conformably pressing the rim portion everted over the frame to the main portion; (3) the internal and external member are provided with cooperatively disposed effectors configured to secure the rim portion and main portion together when the rim and main portions are pressed to each other; (b) providing the bags and frames; (c) inserting the main portion of the bag into the frame; (d) everting the rim portion of the bag over the frame; (e) securing the rim portion to the main portion.

It is another core purpose of the invention to provide the step of securing the rim portion to the main portion further comprises pressing the rim portion to the main portion between the effectors of the internal and external members and coupling the rim and main portions.

### BRIEF DESCRIPTION OF THE DRAWINGS

In order to understand the invention and to see how it may be implemented in practice, a plurality of embodiments is adapted to now be described, by way of non-limiting example only, with reference to the accompanying drawings, in which

FIG. 1 is a general view of a machine for assembling a container accommodating perishable goods;

FIG. 2 is an isometric view of securing means;

FIG. 3 is a schematic view of securing means; and

FIG. 4 illustrates securing a bag to a frame,

### DETAILED DESCRIPTION OF THE INVENTION

The following description is provided, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide a machine for assembling a container accommodating perishable goods and a method of doing the same.

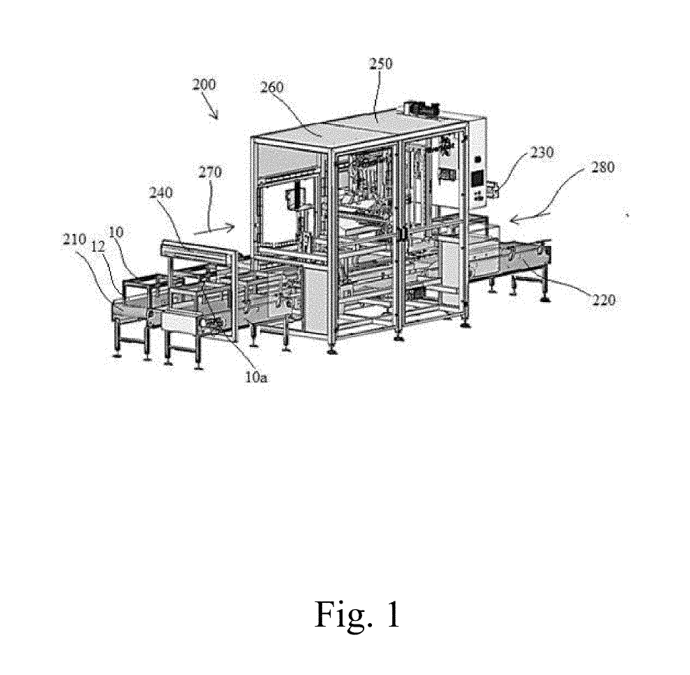

Reference is now made to FIG. 1, presenting a general view of assembling machine 200. The aforesaid machine comprises bag placing module 250 and bag securing module 260. An operation principle of bag placing module 250 is on the market (for example, Pattyn® poly bag inserter). Operation of bag securing module 260 will be described in detail below. Machine 200 includes infeed conveyor 210 and outfeed conveyor 220. Belts of conveyers 210 and 220 move in directions indicated by arrows 270 and 280, respectively. Bags (not shown) are secured to frames 10. According to one embodiment of the present invention, frames 10 are releasably placed onto mountings 12 to be transported by conveyors 210 and 220. The aforesaid conveyors are cyclically interconnected by pushers 330 and 340 which push frames 10 from one conveyor to another during the machine operation. Unequipped frame 10 is placed onto conveyor 210 and pushed by pusher 230 to conveyor 220, which conveys frame 10 to bag placing module 250. After placing the bag (not shown), frame 10 is moved to bag securing module 260 where the bag is thermally welded to frame 10. Other technologies are also in the scope of the present invention. The frame equipped with the bag is indicated by numeral 10a.

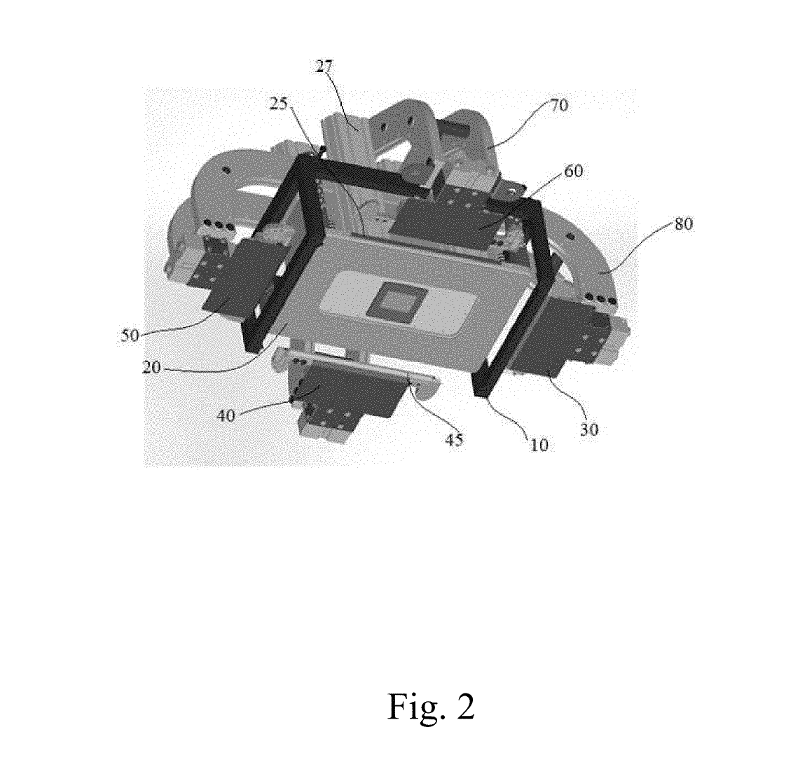

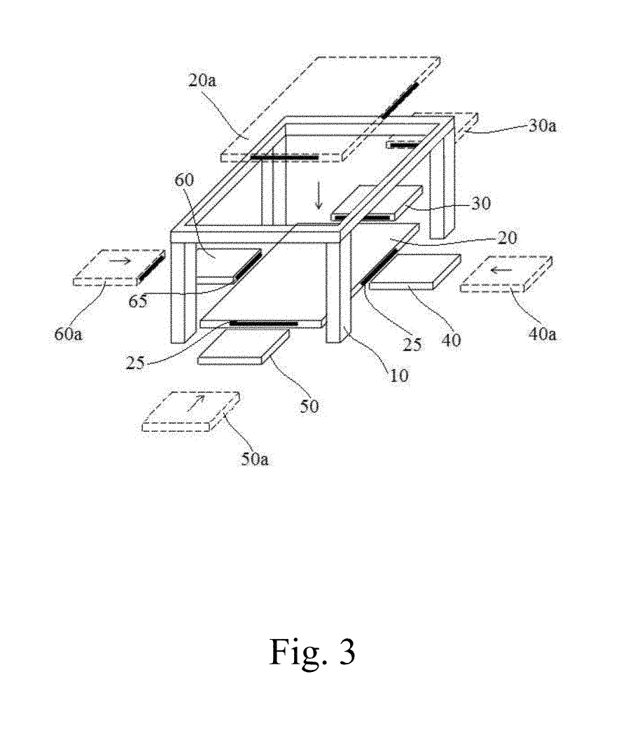

Reference is now made to FIGS. 2 and 3, presenting bag securing means. The principle of operation is in the following. When s main portion of the bag is placed into frame 10 and a rim portion of the bag is everted around frame 10, internal member 20 is inserted into the main portion of the bag, while external members 30, 40, 50 and 60 are outside of the bag. Internal member 20 is carried by bar 27 and provided with heatable body (effector) 25. Similarly, external members 30, 40, 50 and 60 have heatable bodies (effectors) 35, 45, 55 and 65 (respectfully).

As seen in FIG. 3, the internal member is reciprocatively movable between positions 20a (standby position) and 20 (working position) in the vertical direction. External members are reciprocatively movable between positions 30a-30, 40a-40, 50a-50 and 60a-60 in the horizontal direction.

In the working position, effectors press and weld the rim and main portion of the bag to each other.

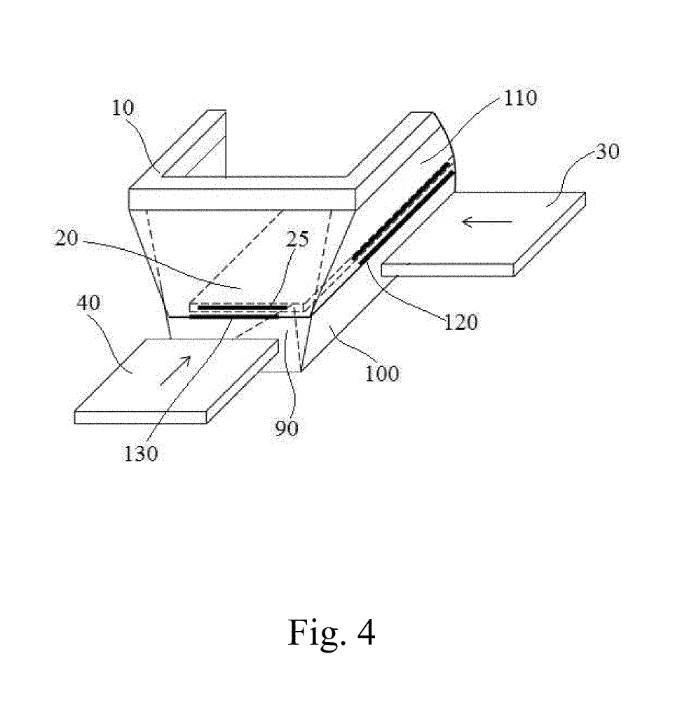

Reference is now made to FIG. 4, presenting an operation of securing the bag having main portion 100 and rim portion 110 to frame 10. As disclosed above, rim portion 110 is everted around frame 10. In FIG. 4, external members 30 and 40 with the corresponding effectors (not shown) and internal member 20 with effectors 25 press rim portion 110 and main portion 100 to each other and form weld lines 120 and 130. After securing the bag to the frame, a ready container is removed by the conveyor from the bag securing module.

According to the present invention, a machine for assembling a container accommodating perishable goods is disclosed. Each container comprises a bag has a main portion and a rim portion adjacent to an open end thereof. The bag is securable to a frame.

The aforesaid machine comprises: (a) bag placing means configured for inserting the bags into the frames and everting the rim portion of the bag over the frame; and (b) bag securing means.

It is a core feature of the invention to provide the bag securing means further comprising: (a) an internal member having a perimeter conformable with a cross section of the bag; the internal member insertable into the main portion of the bag; and (b) at least one external member conformably pressing the rim portion everted over the frame to the main portion. The internal and external members are provided with cooperatively disposed effectors configured to secure the rim portion and main portion together when the rim and main portions are pressed to each other.

According to one embodiment of the present invention, the machine comprises a conveyor having a moving belt configured for carrying the frames through the bag placing means and bag securing means.

According to another embodiment of the present invention, the machine comprising feeding means configured the frame to the conveyor.

According to a further embodiment of the present invention, the machine comprises collecting means configured for collecting assembled container from the conveyor.

According to a further embodiment of the present invention, the conveyor comprises infeed and outfeed portions.

According to a further embodiment of the present invention, the infeed and outfeed portions are parallel to each other and cyclically interconnected by pushing means.

According to a further embodiment of the present invention, the conveyor is provided with a plurality of mountings configured for carrying the frames.

According to a further embodiment of the present invention, the bag has a gusset pattern.

According to a further embodiment of the present invention, the bag is made of a material selected from the group consisting of: polyethylene, polypropylene, paper, jute and any combination thereof.

According to a further embodiment of the present invention, the effectors further comprise a mechanism selected from the group consisting of an ohmic heating element, an ultrasound piezo heating, needle arrangement for stitching and any combination thereof.

According to a further embodiment of the present invention, a method of assembling containers accommodating perishable goods is disclosed. Each container comprises a bag having a main portion and a rim portion adjacent to an open end thereof. The bag is securable to a frame. The method comprising the steps of: (a) providing a machine for assembling containers accommodating perishable goods; the machine comprising (i) bag placing means configured for inserting the bag into the frame and everting the rim portion of the bag over the frame; and (ii) bag securing means; the bag securing means further comprises: (1) an internal member having a perimeter conformable with a cross section of the bag; the internal member insertable into the main portion of the bag; and (2) at least one external member conformably pressing the rim portion everted over the frame to the main portion; (3) the internal and external member are provided with cooperatively disposed effectors configured to secure the rim portion and main portion together when the rim and main portions are pressed to each other; (b) providing the bags and frames; (c) inserting the main portion of the bag into the frame; (d) everting the rim portion of the bag over the frame; (e) securing the rim portion to the main portion.

It is another core feature of the invention to provide the step of securing the rim portion to the main portion further comprises pressing the rim portion to the main portion between the effectors of the internal and external members and coupling the rim and main portions.

We claim:

1. A machine for assembling a container accommodating perishable goods; each container comprising a bag having a main portion and a rim portion adjacent to an open end thereof; said bag being securable to a frame;
said machine comprising.
a. bag placing means configured for inserting said bags into said frames and everting said rim portion of said bag over said frame; and
b. bag securing means;
wherein said bag securing means further comprises:
a. an internal member having a perimeter conformable with a cross section of said bag; said internal member insertable into said main portion of said bag; and
b. at least one external member conformably pressing said rim portion everted over said frame to said main portion;
said internal and external members are provided with cooperatively disposed effectors configured to secure said rim portion and main portion together when said rim and main portions are pressed to each other.

2. The machine according to claim 1 comprising a conveyor having a moving belt configured for carrying said frames through said bag placing means and bag securing means.

3. The machine according to claim 1 comprising feeding means configured for feeding said frame to said conveyor.

4. The machine according to claim 1 comprising collecting means configured for collecting assembled container from said conveyor.

5. The machine according to claim 1, wherein said conveyor comprises infeed and outfeed portions.

6. The machine according to claim 5, wherein said infeed and outfeed portions are parallel to each other and cyclically interconnected by pushing means.

7. The machine according to claim 6, wherein said conveyor is provided with a plurality of mountings configured for carrying said frames.

8. The machine according to claim 1, wherein said bag has a gusset pattern.

9. The machine according to claim 1, wherein said bag is made of a material selected from the group consisting of polyethylene, polypropylene, paper, jute and any combination thereof.

10. The machine according to claim 1, wherein said effectors further comprises a mechanism selected from the group consisting of an ohmic heating element, an ultrasound piezo heating, needle arrangement for stitching and any combination thereof.

11. A method of assembling containers accommodating perishable goods; each container comprising a bag having a main portion and a rim portion adjacent to an open end thereof; said bag being securable to a frame; said method comprising the steps of:
a. providing a machine for assembling containers accommodating perishable goods; said machine comprising:
i. bag placing means configured for inserting said bag into said frame and everting said rim portion of said bag over said frame; and
ii. bag securing means;
said bag securing means further comprises:
i. an internal member having a perimeter conformable with a cross section of said bag, said internal member insertable into said main portion of said bag; and
ii. at least one external member conformably pressing said rim portion everted over said frame to said main portion;
iii. said internal and external member are provided with cooperatively disposed effectors configured to secure said rim portion and main portion together when said rim and main portions are pressed to each other.
b. providing said bags and frames;
c. inserting said main portion of said bag into said frame;
d. everting said rim portion of said bag over said frame;
e. securing said rim portion to said main portion;
wherein said step of securing said rim portion to said main portion further comprises pressing said rim portion to said main portion between said effectors of said internal and external members and coupling said rim and main portions.

12. The method according to claim 11 comprising a step of carrying said frames through said bag placing means and bag securing means by a conveyor having a moving belt configured for carrying.

13. The method according to claim 11 comprising a step of feeding said frame to said conveyor.

14. The method according to claim 11 comprising a step of collecting an assembled container from said conveyor.
